(19) United States
(12) Patent Application Publication
(10) Pub. No.: US 2013/0193772 A1
(43) Pub. Date: Aug. 1, 2013

(54) SURFACE COMMUNICATION DEVICE

(71) Applicant: Naoki Kobayashi, Tokyo (JP)

(72) Inventor: Naoki Kobayashi, Tokyo (JP)

(73) Assignee: NEC CORPORATION, Minato-ku, Tokyo (JP)

(21) Appl. No.: 13/824,179

(22) PCT Filed: Sep. 14, 2011
(86) PCT No.: PCT/JP2011/070958

§ 371 Date: Apr. 19, 2013

(30) Foreign Application Priority Data
Oct. 8, 2010 (JP) 2010-228352

(51) Int. Cl. H02J 17/00

(52) U.S. Cl. CPC H02J 17/00
USPC 307/104

(57) ABSTRACT

A surface communication device includes: a sheet-shaped electromagnetic wave propagation unit that propagates electromagnetic waves; and a power supplying device unit or a power receiving device that is disposed above the electromagnetic wave propagation unit in a non-conductive state with the electromagnetic wave propagation unit, and includes an electromagnetic wave coupling unit that transmits electromagnetic waves to the electromagnetic wave propagation unit or receives electromagnetic waves from the electromagnetic wave propagation unit. The electromagnetic wave coupling unit includes a mesh-shaped conductive coupling element that is disposed facing the electromagnetic wave propagation unit.

### TECHNICAL FIELD

The present invention relates to technology for wirelessly supplying electric power. The present invention, in particular, relates to a surface communication device that supplies electric power from a power supplying side to a sheet, or supplies electric power from a sheet to a power receiving side such as a load.

### BACKGROUND ART

As a means of wirelessly supplying electric by communication using electromagnetic waves, there exists a system in which a power supplying device and a power receiving device are each arranged in a non-conducting manner on a sheet-shaped communication medium, and the electric that is wirelessly supplied from the power supplying device is wirelessly received at the power receiving device side via the sheet-shaped communication medium.

As a modified example of this kind of wireless power supply, there is also a system that performs power supply from a power supplying device to a communication medium by contact power supply, and performs electric receiving from the communication medium to a power receiving device wirelessly. Moreover, as a modified example of that, a system that performs power supply from a power supplying device to a communication medium by wireless power supply, and performs power supply from the communication medium to a power receiving device by contact power supply is also envisaged as a future range of application.

This kind of communication means given above, including the modification exmples, is referred to hereinbelow as surface communication.

Surface communication enables communication between two arbitrary points on a two-dimensional sheet, or the performing of either one of transmission or reception of electric at an arbitrary point on a sheet.

Patent Documents 1 to 4 disclose technology relating to this kind of wireless power supply.

The signal transmission device that is shown in Patent Document 1 has a first conductor unit, a second conductor unit, a sandwiched region, and a transpiration region. The first conductor unit is a mesh shape, and is a conductor in the electromagnetic frequency band. The second conductor unit has a plate shape external form, is arranged parallel to the first conductor unit, and is a conductor in the electromagnetic frequency band. The sandwiched region is arranged so as to be sandwiched by the first conductor unit and the second conductor unit. The transpiration region is plate-shaped and is provided on the upper surface of the first conductor unit. This signal transmission device transmits signals by changes in the electromagnetic field. The signal transmission system shown in the cited document 2 has a signal transmitter and an interface device. The signal transmitter is sheet-shaped and has a conductor unit and a mesh-shaped second conductor unit. The interface device is provided above the signal transmitter, whereby signals from a communication device are transmitted and received. This interface device performs communication with the signal transmitter via changes in the electromagnetic field (evanescent field) near the outer side of the first conductor unit of the signal transmitter.

The power supply system that is shown in Patent Document 3 includes an electromagnetic wave propagation device that is constituted in a sheet shape and propagates electromagnetic waves, and a power supplying device that outputs electromagnetic waves to the electromagnetic wave propagation device. A plurality of electrodes that output electromagnetic waves to the electromagnetic wave propagation device are arranged in an array on a substrate at the lower surface of the power supplying device.

The electromagnetic wave interface device shown in Patent Document 4 supplies or receives electric to/from an electromagnetic wave transduction medium that has a mesh-shaped electrode. This electromagnetic wave interface device is constituted from a first conductor with a spiral shape that is arranged closely to a first conductor layer in a manner approximately parallel therewith, a second conductor that is arranged to face the first conductor in a manner approximately parallel therewith, and a dielectric that is arranged between the first conductor and the second conductor.

Non-patent Document 1 discloses a principle of power communication on a sheet-shaped communication medium.

### Prior Art Documents

### [Patent Documents]

[Patent Document 1] PCT International Publication No. 2007-32049

[Patent Document 2] Japanese Unexamined Patent Application, First Publication No. 2007-82178

[Patent Document 3] Japanese Unexamined Patent Application, First Publication No. 2008-295176

[Patent Document 4] Japanese Unexamined Patent Application, First Publication No. 2010-93446

### Non-Patent Document

[Non-Patent Document 1] Hiroyuki Shinoda, “High Speed Sensor Network Formed on Material Surfaces,” Journal of the Society of Instrument and Control Engineers, February 2007, Vol. 46, No. 2, pp. 98-103.

### SUMMARY OF THE INVENTION

### Problem to be Solved by the Invention

There are the following problems in surface communication as it stands now.

Generally, the power transmission efficiency, that is, the communication performance, between a power supplying device unit and a power receiving device unit depends on the power transmission efficiency between the power supplying device unit and the sheet-shaped communication medium (electromagnetic wave propagation unit), and between the sheet-shaped communication medium and the power receiving device unit. A plate-shaped conductive coupling element also called a patch antenna is mounted in the power supplying device unit or the power receiving device unit so as to be sandwiched by the reference ground thereof and the communication medium. This conductor coupling element is designed so that the transported amount of electric power increases due to its resonating at a specified frequency.

Ideally, in the case of a power supplying device unit, all of the electric power that is supplied from the power supplying device unit should be able to be fed to the sheet-shaped communication medium. However, in reality the electromagnetic coupling between the power supplying device unit and the sheet-shaped communication medium becomes insufficient, and a portion of the electric power leaks out to the outside as electromagnetic waves. A primary factor of that insufficient electromagnetic coupling is considered to be a large portion of the electromagnetic field surrounding the plate-shaped conductive coupling element being concentrated between the reference ground of the power supplying device unit and the conductive coupling element.

In the case of the power receiving device unit, all of the electric power that is received by the power receiving device unit should be able to be received from the sheet-shaped communication medium. However, in reality the electromagnetic coupling becomes insufficient, and it either remains on the sheet side as electromagnetic waves without being received, or leaks out to the outside as electromagnetic waves from the gap between the power receiving device unit and the sheet-shaped communication medium. A primary factor of that insufficient electromagnetic coupling is considered to be a large portion of the electromagnetic field surrounding the plate-shaped conductive coupling element being concentrated between the reference ground of the power receiving device unit and the conductive coupling element. As a result, the communication performance falls. For that reason, a structure is desired for strengthening the electromagnetic coupling of the power supplying device unit or the power receiving device unit with respect to the sheet-shaped communication medium.

### Means for Solving the Problem

An exemplary object of the present invention is providing a surface communication device that can solve the aforementioned issues.

In order to solve the aforementioned issues, a surface communication device according to an exemplary aspect of the present invention includes: a sheet-shaped electromagnetic wave propagation unit that propagates electromagnetic waves; a power supplying device unit that is disposed above the electromagnetic wave propagation unit in a non-conductive state with the electromagnetic wave propagation unit, and includes an electromagnetic wave coupling unit that transmits electromagnetic waves to the electromagnetic wave propagation unit; and a power receiving device unit that is disposed above the electromagnetic wave propagation unit in a non-conductive state with the electromagnetic wave propagation unit, and includes an electromagnetic wave coupling unit that receives electromagnetic waves from the electromagnetic wave propagation unit. At least one of the electromagnetic wave coupling units of the power supplying device unit and the power receiving device unit includes a mesh-shaped conductive coupling element that is disposed facing the electromagnetic wave propagation unit.

### Effect of the Invention

According to the present invention, in at least one of the electromagnetic wave coupling units of a power supplying device unit and a power receiving device unit that are provided in a non-conductive state with an electromagnetic wave propagation unit, a mesh-shaped conductive coupling element that is disposed so as to face the electromagnetic wave propagation unit is included. By this conductive coupling element, the electromagnetic coupling between the electromagnetic wave propagation unit that serves as a communication medium and the electromagnetic wave coupling unit is strengthened. As a result, it is possible to improve the communication performance of the surface communication device.

### BRIEF DESCRIPTION OF THE DRAWINGS

FIG. 1 is a frontal cross-sectional view that shows a surface communication device according to one exemplary embodiment of the present invention.

FIG. 2 is a plan view of a mesh layer of an electromagnetic wave propagation sheet shown in FIG. 1.

FIG. 3 is a frontal cross-sectional view that shows the vicinity of a power supplying device unit shown in FIG. 1.

FIG. 4 is a frontal cross-sectional view for describing an action of the power supplying device unit shown in FIG. 1.

FIG. 5 is a frontal cross-sectional view that shows Modified Example 1 of the surface communication device shown in FIG. 1.

FIG. 6 is a frontal cross-sectional view that shows Modified Example 2 of the surface communication device shown in FIG. 1.

FIG. 7 is a frontal cross-sectional view that shows Modified Example 3 of the surface communication device shown in FIG. 1.

FIG. 8 is a frontal cross-sectional view that shows Modified Example 4 of the surface communication device shown in FIG. 1.

FIG. 9 is a frontal cross-sectional view that shows Modified Example 5 of the surface communication device shown in FIG. 1.

FIG. 10 is a frontal cross-sectional view that shows Modified Example 6 (1) of the surface communication device shown in FIG. 1.

FIG. 11 is a frontal cross-sectional view that shows Modified Example 6 (2) of the surface communication device shown in FIG. 10.

FIG. 12 is a frontal cross-sectional view that shows Modified Example 6 (3) of the surface communication device shown in FIG. 10.

### EMBODIMENTS FOR CARRYING OUT THE INVENTION

One exemplary embodiment of the present invention shall be described with reference to FIG. 1 to FIG. 12.

FIG. 1 is a frontal cross-sectional view that shows the structure of a surface communication device according to a present exemplary embodiment. This surface communication device has an electromagnetic wave propagation sheet 1 that serves as an electromagnetic wave propagation unit serving as a communication medium.

The electromagnetic wave propagation sheet 1 is a constitution in which an electromagnetic wave propagation layer 3, a mesh layer 4, and a protective layer 5 are laminated in sequence on a conductive plane layer 2. Electromagnetic waves that are supplied from a power supplying device unit 10 (described below) that is installed on the upper surface of the electromagnetic wave propagation sheet 1 are, after being propagated in a direction along the sheet surface of the electromagnetic wave propagation sheet 1, transmitted to a power receiving device unit 20 (described below).

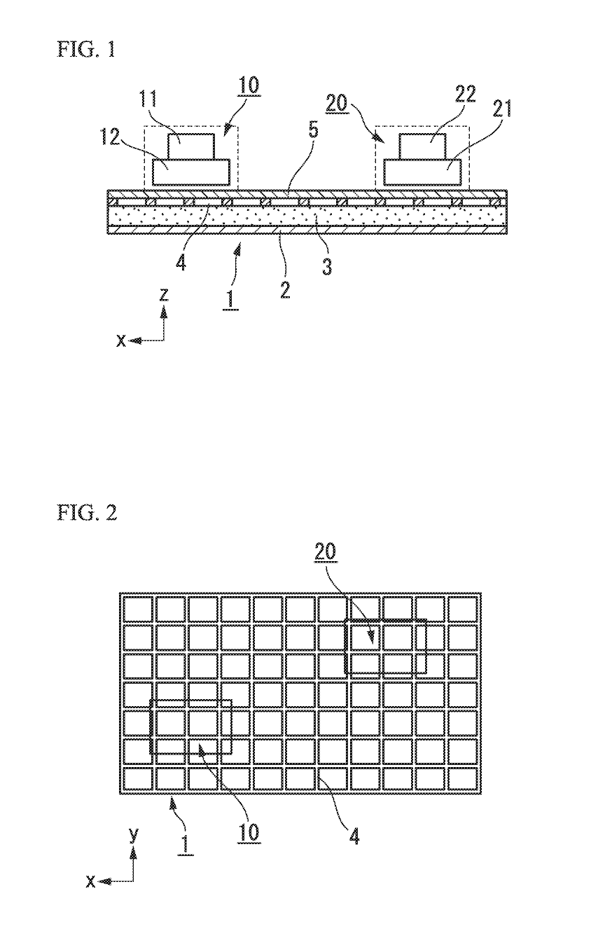

FIG. 2 is a plan view that shows the mesh layer 4 of the electromagnetic wave propagation sheet 1. As shown in FIG. 2, the mesh layer 4 is a conductor that is formed in a mesh shape.

The electromagnetic wave propagation layer 3 is a space that is sandwiched by the mesh layer 4 and the conductive plane layer 2. Electromagnetic waves are propagated in a direction along the surface of the sheet within this space.

The protective layer 5 is provided so that the power supplying device unit 10 or the power receiving device unit 20, and the electromagnetic wave propagation layer 3 are not mutually conductive. The medium material of the protective layer 5 is a medium material that has a specified permittivity and magnetic permeability, and does not pass direct current. As the medium of the protective layer 5, air or a vacuum is included.

The power supplying device unit 10 that serves as the electromagnetic wave transmitting unit and the power receiving device unit 20 that serves as the electromagnetic wave receiving unit are installed as shown in FIG. 1 on the upper surface of the electromagnetic wave propagation sheet 1.

The power supplying device unit 10 and the power receiving device unit 20 can be installed in a plurality on the electromagnetic wave propagation sheet 1. Also, the power supplying device unit 10 and the power receiving device unit 20 may be detachably provided on the electromagnetic wave propagation sheet 1.

The power supplying device unit 10 and the power receiving device unit 20 are provided at arbitrary locations on the electromagnetic wave propagation sheet 1 in a non-conductive state with no conductor contact via the protective layer 5 in the electromagnetic wave propagation sheet 1. Here, a sheet shape means one that has a surficial spread and thin thickness, such as a cloth shape, a paper shape, a foil shape, a plate shape, a membrane shape, a film shape, or a mesh shape.

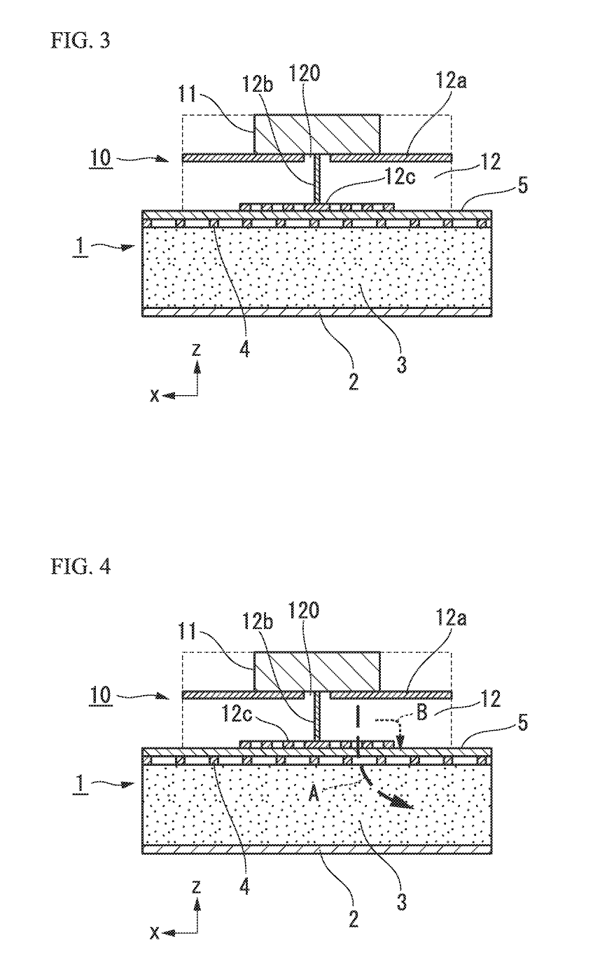

The power supplying device unit 10 includes an electromagnetic wave generating unit 11 and a transmission electromagnetic wave coupling unit 12, as shown in FIG. 3 and FIG. 4. The power supplying device unit 10 is arranged in an opposing positional relationship with respect to the electromagnetic wave propagation sheet 1.

The transmission electromagnetic wave coupling unit 12 is provided facing the electromagnetic wave generating unit 11. The transmission electromagnetic wave coupling unit 12 has a reference conductor 12a that has an opening 120, a conductor post 12b, and a conductive coupling element 12c that is conductor connected via the conductor post 12b to the electromagnetic wave generating unit 11. The conductive coupling element 12c is arranged in an opposing positional relationship with respect to the electromagnetic wave propagation sheet 1. The conductive coupling element 12c pumps electromagnetic waves generated by the electromagnetic wave generating unit 11 into the electromagnetic wave propagation layer 3 via the mesh layer 4. By providing the conductive coupling element 12c in the transmission electromagnetic wave coupling unit 12, the electromagnetic coupling between the electromagnetic wave propagation sheet 1 that serves as a communication medium and the electromagnetic wave coupling unit 12 is strengthened. As a result, it is possible to improve the communication performance of a surface communication device.

The conductive coupling element 12c is constituted from a conductor element with a mesh shape that opposes the protective layer 5 of the electromagnetic wave propagation sheet 1. This means that in the case of the conductive coupling element 12c resonating at a specified frequency, electromagnetic waves seep out from the mesh-shaped conductor structure to the electromagnetic wave propagation sheet 1 on the communication medium side. That is to say, in the conductive coupling element 12c of the transmission electromagnetic wave coupling unit 12 shown in the present exemplary embodiment, the region in which the electromagnetic field distribution is in contact with the communication medium increases compared with the case of using a plate-shaped conductor as the conductive coupling element. As a result, the electromagnetic coupling between the power supplying device unit 10 and the electromagnetic wave propagation sheet 1 that is the communication medium is strengthened.

FIG. 4 shows the state of the electromagnetic wave coupling between the transmission electromagnetic wave coupling unit 12 and the electromagnetic wave propagation sheet 1 that is the communication medium. As shown in FIG. 4, the propagation path of electromagnetic waves that are conveyed from the conductive coupling element 12c to the electromagnetic wave propagation sheet 1 that is directly below it is shown by the dashed line (symbol A). This shows that, since the mesh-shaped conductor of the conductive coupling element 12c and the electromagnetic wave propagation sheet 1 are directly electromagnetically coupled, electromagnetic waves directly propagate from this mesh-shaped conductor to the electromagnetic wave propagation sheet 1.

The case of using a conventional plate-shaped conductor as the conductive coupling element shall be described. In this case, as the propagation path of the electromagnetic waves that are radiated from the conductive coupling element 12c, the path that is shown by the symbol A is not included. The propagation path of the electromagnetic waves that are radiated from the conductive coupling element 12c couples to the communication medium side after once escaping to the side of the conductive coupling element, as shown by the path shown by the dotted line (symbol B). As a result, the electromagnetic coupling between the power supplying device unit 10 and the electromagnetic wave propagation sheet 1 that is the communication medium worsens.

In contrast to this, in the transmission electromagnetic wave coupling unit 12 that is shown in the present exemplary embodiment, the mesh-shaped conductor of the conductive coupling element 12c and the electromagnetic wave propagation sheet 1 are directly electromagnetically coupled as shown by the symbol A. As a result, the electromagnetic coupling between the power supplying device unit 10 and the electromagnetic wave propagation sheet 1 that is the communication medium is strengthened.

Next, the power receiving device unit 20 that receives the electromagnetic waves that have been output from the power supplying device unit 10 and that have propagated through the electromagnetic wave propagation sheet 1 shall be described.

The power receiving device unit 20 is constituted from a reception electromagnetic wave coupling unit 21 that receives electromagnetic waves that propagate through the electromagnetic wave propagation sheet 1, and an electromagnetic wave input unit 22 to which the received electromagnetic waves is input. The reception electromagnetic wave coupling unit 21 basically is a constitution that has a reference conductor 12a and a conductor post 12b, and a conductive coupling element 12c, in the same manner as the transmission electromagnetic wave coupling unit 12 of the aforementioned power supplying device unit 10. For this reason, overlapping descriptions on the reception electromagnetic wave coupling unit 21 shall be omitted. That is to say, in the case of supplying electric power, electromagnetic waves are pumped to the electromagnetic wave propagation sheet 1, while in the case of receiving electric power, conversely electromagnetic waves propagated by the electromagnetic wave propagation sheet 1 are received.

According to the exemplary embodiment of the present invention as described in detail hereinabove, the mesh-shaped conductive coupling element 12c is included so as to face the electromagnetic wave propagation sheet 1 in at least one of the electromagnetic wave coupling unit 12 of the power supplying device unit 10 and the electromagnetic wave coupling unit 21 of the power receiving device unit 11, which are provided in a non-conductive state with the electromagnetic wave propagation sheet 1 that serves as an electromagnetic wave propagation unit. By this conductive coupling element 12c, the electromagnetic coupling between the electromagnetic wave propagation sheet 1 that is the communication medium and the electromagnetic wave coupling units 12 and 21 is strengthened, and it is possible to improve the communication performance of the surface communication device.

The exemplary embodiment of the present invention may be modified as shown below.

### MODIFIED EXAMPLE 1

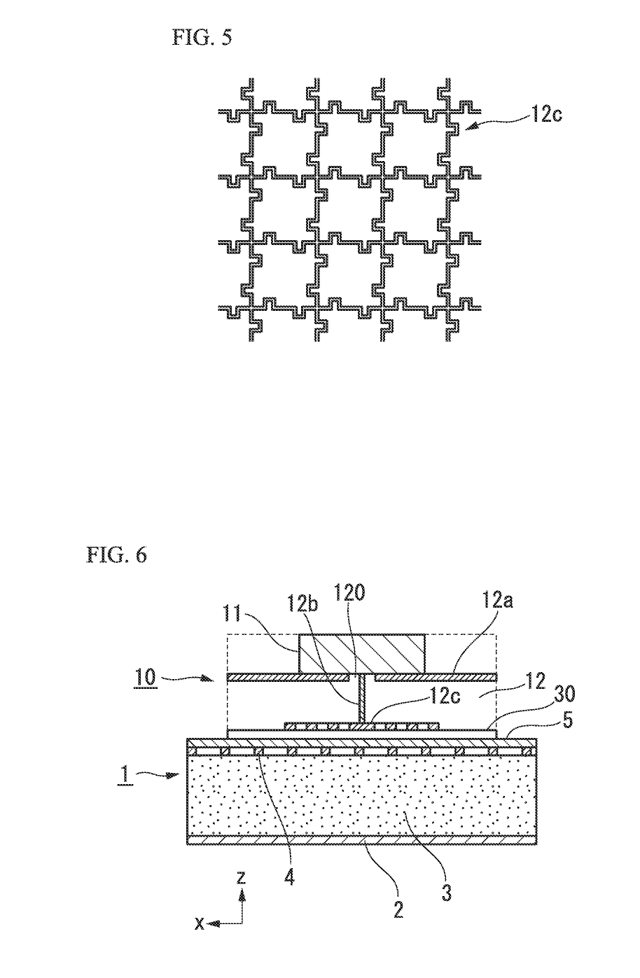

In the aforementioned exemplary embodiment, the conductive coupling element 12c of the transmission electromagnetic wave coupling unit 12 is formed in a mesh state by linear wires, but is not limited to this constitution. The conductive coupling element 12c may have a meander shape in which the linear wires meander as shown in FIG. 5.

Specifically, in the conductive coupling element 12c, the wires that connect mutually adjacent unit structures meander. Thereby, the inductance of the mesh-shaped conductive element increases, and it is possible to make the resonance frequency of the mesh-shaped element be a lower frequency. This means it is possible to reduce the size of the structure of the mesh-shaped conductive element for resonating at a specified frequency, and so it is possible to miniaturize the power supplying device unit 10.

In the aforementioned exemplary embodiment, the mesh shape of the conductive coupling element 12c is made rectangular. However, the mesh shape need not be rectangular. The mesh shape may for example be any polygonal shape or a shape that includes a smooth boundary such as a circle. Also, the conductors that mutually cross in the mesh-shaped conductive element 12c need not be perpendicular to each other. For example, the unit structure of the mesh may be any polygonal structure such as hexagonal.

### MODIFIED EXAMPLE 2

In the aforementioned exemplary embodiment, the mesh-shaped conductive coupling element 12c of the transmission electromagnetic wave coupling unit 12 is arranged so as to face the electromagnetic wave propagation sheet 1, but is not limited to this constitution. As shown in FIG. 6, an insulation layer 30 may be coated on the bottom surface of the power supplying device unit 10 or the power receiving device unit 20. By this insulation layer 30, when the power supplying device unit 10 or the power receiving device unit 20 is removed from the electromagnetic wave propagation sheet 1, inadvertent electrical contact with the surroundings is prevented. The coating of the insulation layer 30 may be performed on either of the power supplying device unit 10 or the power receiving device unit 20, or may be performed on both.

### MODIFIED EXAMPLE 3

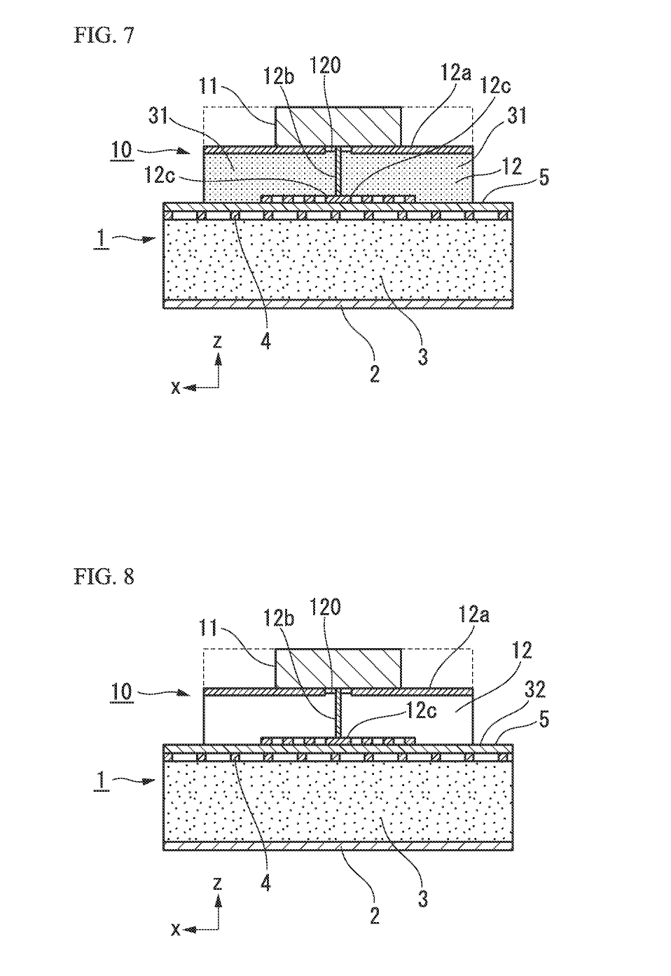

In the transmission electromagnetic wave coupling unit 12 of the exemplary embodiment described above, as shown in FIG. 7, a high-permittivity material 31 with a higher permittivity than the protective layer 5 on the electromagnetic wave propagation sheet 1 that is on the communication medium side may be filled in the space between the conductive coupling element 12c and the reference conductor 12a. By using the high-permittivity material 31 as the electromagnetic wave coupling unit 12, it is possible to lower the resonance frequency of the conductive coupling element 12c. For that reason, it is possible to reduce the size of the structure of the mesh-shaped conductive element 12c for resonating at a specified frequency, and so it is possible to miniaturize the power supplying device unit 10. The filling of this high-permittivity material 31 may be performed in either of the power supplying device unit 10 and the power receiving device unit 20, or may be performed in both.

### MODIFIED EXAMPLE 4

In the aforementioned exemplary embodiment, as shown in FIG. 8, a high-permittivity material 32 having a higher permittivity than the permittivity of the high-permittivity material 31 that fills the electromagnetic wave coupling unit 12 may be used as the protective layer 5 on the electromagnetic wave propagation sheet 1 that is the communication medium. By using the high-permittivity material 32 for the material of the protective layer 5, it is possible to strengthen the electromagnetic coupling between the conductive coupling element 12c and the electromagnetic wave propagation sheet 1 that is the communication medium. As a result, it is possible to raise the power transmission efficiency of the surface communication structure.

### MODIFIED EXAMPLE 5

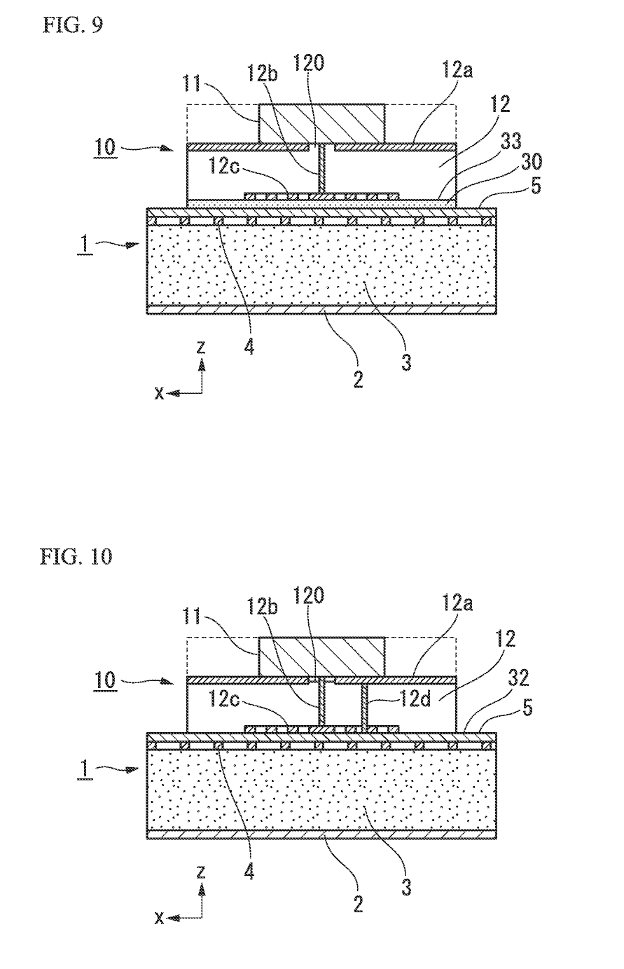

In the aforementioned exemplary embodiment, as shown in FIG. 9, a high-permittivity material 33 having a permittivity that is higher than the permittivity of the high-permittivity material 31 that fills the electromagnetic wave coupling unit 12 may be used as the insulation material of the insulation layer 30 that constitutes the lower surface of the electromagnetic wave coupling unit 12 in FIG. 6.

By using the high-permittivity material 33 for a coating material that serves as the insulation layer 30, it is possible to strengthen the electromagnetic coupling between the conductive coupling element 12c and the electromagnetic wave propagation sheet 1.

As a result, it is possible to raise the power transmission efficiency of the surface communication structure.

### MODIFIED EXAMPLE 6

In the aforementioned exemplary embodiment, the conductive coupling element 12c and the reference conductor 12a are positioned apart, but the two need not always be insulated. As an example in which the conductive coupling element 12c and the reference conductor 12a are not insulated, a case is included in which the mesh-shaped conductor element 12c and the reference conductor 12a are partially connected by an additional conductor post 12d as shown in FIG. 10. In FIG. 10, only one additional conductor post 12d is shown, but there may be a plurality. Moreover, provided it causes conductivity between the conductive coupling element 12c and the reference conductor 12a, it need not be shaped as a post. For example, the circumference of the conductive coupling element 12c may be surrounded with a conductive wall.

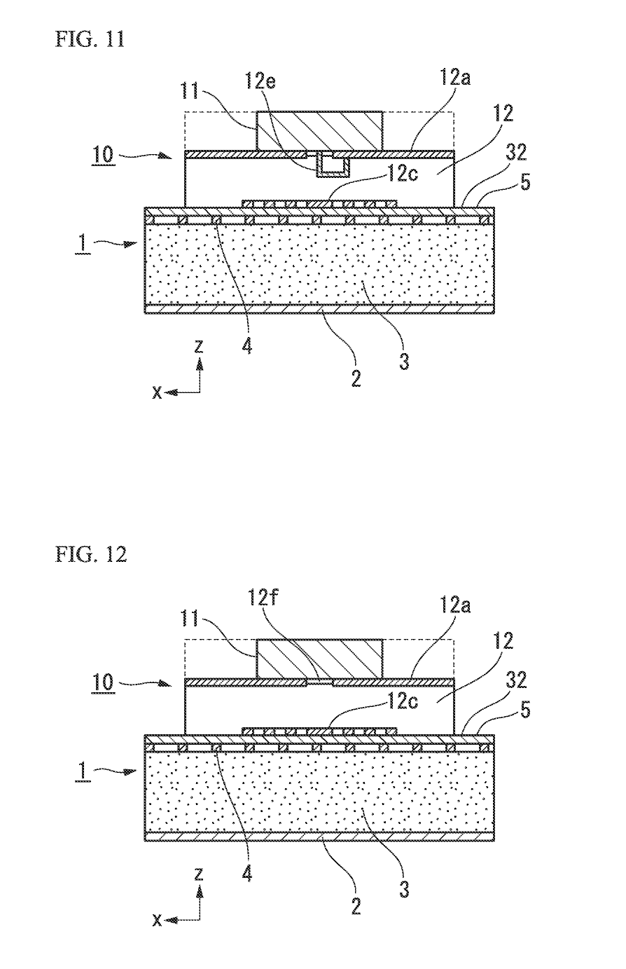

In each of the above exemplary embodiments, the mesh-shaped conductor element 12c and the electromagnetic wave generating unit 11 are conductor connected by the conductor posts 12b and 12d, but they need not always be conductor connected. As an example of not being conductor connected, the case is included of a loop-shaped conductor 12e being used instead of a conductor post as shown in FIG. 11.

Moreover, the conductor posts 12b and 12d need not always be present. As an example of there being no conductor posts 12b and 12d, the case is included of a slit 12b being used instead of a conductor as a matching element, as shown in FIG. 12. Due to the slit 12f, the effect is exhibited of electromagnetic coupling of the electromagnetic waves that propagate via the slit 12f with the electromagnetic wave coupling units 12 and 21 being facilitated.

The conductor posts 12b and 12d of FIG. 10, the loop-shaped conductor 12e of FIG. 11, and the slit 12f of FIG. 12 may be arranged in either of the power supplying device unit 10 or the power receiving device unit 20, or may be arranged in both.

A surface communication device of the present invention is not limited to the aforementioned exemplary embodiment that is described referring to the drawings, with various modified examples being conceivable within the technical scope thereof. For example, various modified examples are possible to the constituent elements or combinations of processes thereof given in the aforementioned exemplary embodiments.

Specifically, in the aforementioned exemplary embodiment, both of the power supplying device unit 10 and the power receiving device unit 20 are provided, but either one only may be provided. For example in the case of only the power supplying device unit 10 being provided, electromagnetic waves that are supplied to the power receiving device unit 20 may be performed by contact power supply. In the case of only the power receiving device unit 20 being provided, electromagnetic waves that are supplied to the power supplying device unit 10 may be performed by contact power supply.

In the present exemplary embodiment, both the power supplying device unit 10 and the power receiving device unit 20 are provided, but a device unit on the side that employs contact power supply, by being added in a separate process, may be removed from the constituent elements.

In the aforementioned exemplary embodiment, only one mesh-shaped conductor that constitutes the conductive coupling element 12c is provided in the electromagnetic wave coupling unit 12, but it need not necessarily be one. For example, there may be two, or three, or an array of the mesh-shaped conductors. Generally, increasing the array number has the effect of strengthening the coupling between the electromagnetic wave coupling unit 12 and the electromagnetic wave propagation sheet 1.

The mesh-shaped conductors that constitute a plurality of conductive coupling elements need not necessarily have the same structure.

In the aforementioned exemplary embodiment, a structure is shown as an example in which the conductive coupling element 12c of the power supplying device unit 10 or the conductive coupling element 12c of the power receiving device unit 20 makes contact with the electromagnetic wave propagation sheet 1 in a non-conducting manner, but they may also be arranged by sandwiching a gap.

In the aforementioned exemplary embodiment, FIG. 2 shows an example in which the shape of the openings in the mesh layer of the electromagnetic wave propagation sheet 1 is rectangular, but it is not limited to this shape. Provided it is a structure that can be applied as an electromagnetic wave propagation sheet 1, the shape of the openings can be changed to various shapes. For example, the opening shape may be hexagonal, may be triangular, or may be circular.

The exemplary embodiment of the present invention can also be used as a surface communication device with the object of propagating electrical power as energy from the power supplying device side to the power receiving device side, and simultaneously can be used as a surface communication device with the object of propagating electrical power as communication data from the power supplying device side to the power receiving device side.

For example, it can also be used with the object of mounting a plurality of pairs of power supplying devices and power receiving devices on the electromagnetic wave propagation sheet 1, and propagating electrical power as energy by some of the pairs of power supplying devices and power receiving devices, and propagating electrical power as communication as data from the power supplying device side to the power receiving device side with the remaining pairs of power supplying devices and power receiving devices.

In the foregoing, though the present invention has been described referring to the exemplary embodiment, the present invention is by no means limited to the afore-described exemplary embodiment. Various modifications in the forms and details of the present invention that could be understood by a person skilled in the art can be made within the scope of the present invention.

This application is based upon and claims the benefit of priority from Japanese patent application No. 2010-228352, filed Oct. 8, 2010, the disclosure of which is incorporated herein in its entirety by reference.

### INDUSTRIAL APPLICABILITY

The present invention can be applied to technology for wirelessly supplying electrical power. The present invention in particular can be applied to a surface communication device that supplies electric power from a power supplying side to a sheet, or supplies electric power from a sheet to a power receiving side such as a load.

### REFERENCE SYMBOLS

1 Electromagnetic wave propagation sheet (electromagnetic wave propagation unit)
5 Protective layer
10 Power supplying device unit
12 Transmission electromagnetic wave coupling unit
12a Reference conductor
12b Conductor post
12c Conductive coupling element
12d Conductor post
12e Loop-shaped conductor
12f Slit
20 Power receiving device unit
21 Reception electromagnetic wave coupling unit
30 Insulation layer
31 High-permittivity material
32 High-permittivity material
33 High-permittivity material

1. A surface communication device comprising:
a sheet-shaped electromagnetic wave propagation unit that propagates electromagnetic waves; and
a power supplying device unit that is disposed above the electromagnetic wave propagation unit in a non-conductive state with the electromagnetic wave propagation unit, the power supplying device unit including an electromagnetic wave coupling unit that transmits electromagnetic waves to the electromagnetic wave propagation unit,
the electromagnetic wave coupling unit including a mesh-shaped conductive coupling element that is disposed facing the electromagnetic wave propagation unit.

2. A surface communication device comprising:
a sheet-shaped electromagnetic wave propagation unit that propagates electromagnetic waves; and
a power receiving device unit that is disposed above the electromagnetic wave propagation unit in a non-conductive state with the electromagnetic wave propagation unit, the power receiving device unit including an electromagnetic wave coupling unit that receives electromagnetic waves from the electromagnetic wave propagation unit,
the electromagnetic wave coupling unit including a mesh-shaped conductive coupling element that is disposed facing the electromagnetic wave propagation unit.

3. A surface communication device comprising:
a sheet-shaped electromagnetic wave propagation unit that propagates electromagnetic waves;
a power supplying device unit that is disposed above the electromagnetic wave propagation unit in a non-conductive state with the electromagnetic wave propagation unit, the power supplying device unit including an electromagnetic wave coupling unit that transmits electromagnetic waves to the electromagnetic wave propagation unit; and
a power receiving device unit that is disposed above the electromagnetic wave propagation unit in a non-conductive state with the electromagnetic wave propagation unit, the power receiving device unit including an electromagnetic wave coupling unit that receives electromagnetic waves from the electromagnetic wave propagation unit,
the electromagnetic wave coupling units of the power supplying device unit and the power receiving device unit each including a mesh-shaped conductive coupling element that is disposed facing the electromagnetic wave propagation unit.

4. The surface communication device according to claim 3, wherein the mesh-shaped conductive coupling element includes a meander-shaped wiring.

5. The surface communication device according to claim 3, wherein the mesh-shaped conductive coupling element is disposed between a reference conductor of the electromagnetic wave coupling unit and a mesh-shaped conductive layer of the electromagnetic wave propagation unit.

6. The surface communication device according to claim 3, wherein at least one of the power supplying device unit and the power receiving device unit includes an insulation layer that is coated on a bottom surface on a side facing the electromagnetic wave propagation unit.

7. The surface communication device according to claim 3, wherein a high-permittivity material higher in permittivity than a protective layer of the electromagnetic wave propagation unit is filled in a space between the conductive coupling element and a reference conductor of at least one of the power supplying device unit and the power receiving device unit.

8. The surface communication device according to claim 7, wherein the protective layer of the electromagnetic wave propagation unit including a high-permittivity material having a higher permittivity than a permittivity of the high-permittivity material filling the space.

9. The surface communication device according to claim 3, wherein the conductive coupling element of at least one of the power supplying device unit and the power receiving device unit, and a reference conductor are connected by a conductor post.

10. The surface communication device according to claim 3, wherein a loop-shaped conductor is disposed between the conductive coupling element of at least one of the power supplying device unit and the power receiving device unit, and a reference conductor.
